(19) United States
(12) Patent Application Publication
(10) Pub. No.: US 2026/0184483 A1
(43) Pub. Date: Jul. 2, 2026

(54) CARRIER FOR CONTAINERS

(71) Applicant: Graphic Packaging International, LLC, Atlanta, GA (US)

(72) Inventor: Zachary Weston, Smyrna, GA (US)

(21) Appl. No.: 19/434,540

(22) Filed: Dec. 29, 2025

Related U.S. Application Data
(60) Provisional application No. 63/739,990, filed on Dec. 30, 2024.
(60) Provisional application No. 63/739,991, filed on Dec. 30, 2024.

(51) Int. Cl. B65D 71/48; B31B 50/26; B31B 100/00; B31B 110/10; B65D 5/42; B65D 5/44; B65D 5/468

(52) U.S. Cl. CPC B65D 71/48; B31B 50/262; B65D 5/4266; B65D 5/441; B65D 5/4608; B31B 2100/002; B31B 2110/10; B31B 2241/001

(57) ABSTRACT

A carrier for holding a plurality of containers, the carrier includes a front portion, a back portion, and a reinforcement portion extending from the front portion to the back portion for reinforcing the carrier, one of the front portion and the back portion of the carrier including at least a portion of a bottom panel for at least partially receiving a respective container of the plurality of containers, at least one side panel, and a reinforcement panel, the carrier further including gripping features including at least one gripping panel extending between the bottom panel and the at least one side panel for facilitating grasping of the carrier.

### CROSS-REFERENCE TO RELATED APPLICATIONS

This application claims the benefit of U.S. Provisional Patent Application No. 63/739,990, filed on Dec. 30, 2024, and U.S. Provisional Patent Application No. 63/739,991, filed on Dec. 30, 2024.

### INCORPORATION BY REFERENCE

The disclosures of U.S. Provisional Patent Application No. 63/739,990 , filed on Dec. 30, 2024, and U.S. Provisional Patent Application No. 63/739,991 , filed on Dec. 30, 2024, are hereby incorporated by reference for all purposes as if presented herein in their entirety.

### BACKGROUND OF THE DISCLOSURE

The present disclosure generally relates to cartons or carriers for holding, displaying, and/or transporting containers.

### SUMMARY OF THE DISCLOSURE

According to one aspect, the disclosure is generally directed to a carrier for holding a plurality of containers, the carrier comprising a front portion, a back portion, and a reinforcement portion extending from the front portion to the back portion for reinforcing the carrier, one of the front portion and the back portion of the carrier comprising at least a portion of an attachment panel for at least partially receiving a respective container of the plurality of containers, at least one side panel, a top panel, and a reinforcement panel, the carrier further comprising gripping features comprising at least one gripping region interrupting a fold line between the attachment panel and the at least one side panel for facilitating grasping of the carrier.

In another aspect, the disclosure is generally directed to a carrier for holding a plurality of containers, the carrier comprising a bottom panel for at least partially receiving a respective container of the plurality of containers, the bottom panel having a plurality of container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers. A front portion of the carrier comprising a first portion of the bottom panel including front bottom container retention features of the plurality of bottom container retention features, at least one front side panel foldably connected to the bottom panel, and a front reinforcement panel. A back portion of the carrier comprising a second portion of the bottom panel including back bottom container retention features of the plurality of bottom container retention features, at least one back side panel, and a back reinforcement panel. A reinforcement portion of the carrier extending from the front portion to the back portion for reinforcing the carrier, the reinforcement portion comprises the front reinforcement panel and the back reinforcement panel in at least partial face-to-face contact. Gripping features for enhancing the grip of the carrier, the gripping features comprising at least one gripping panel extending between the bottom panel and one of the front side panel and the back side panel.

According to another aspect, the disclosure is generally directed to a blank for forming a carrier for holding a plurality of containers, the blank comprising a front portion, a back portion, and a reinforcement portion extending from the front portion to the back portion for reinforcing the carrier formed from the blank, one of the front portion and the back portion of the blank comprising at least a portion of an attachment panel for at least partially receiving a respective container of the plurality of containers, at least one side panel, a top panel, and a reinforcement panel, the carrier further comprising gripping features comprising at least one gripping region interrupting a fold line between the attachment panel and the at least one side panel for facilitating grasping of the carrier formed from the blank.

In another aspect, the disclosure is generally directed to a blank for forming a carrier for holding a plurality of containers, the blank comprising a bottom panel for at least partially receiving a respective container of the plurality of containers in the carrier formed from the blank, the bottom panel having a plurality of container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers in the carrier formed from the blank. A front portion of the blank for forming a front portion of the carrier formed from the blank, the front portion of the blank comprising a first portion of the bottom panel including front bottom container retention features of the plurality of bottom container retention features, at least one front side panel foldably connected to the bottom panel, and a front reinforcement panel. A back portion for forming a back portion of the carrier formed from the blank, the back portion of the blank comprising a second portion of the bottom panel including back bottom container retention features of the plurality of bottom container retention features, at least one back side panel, and a back reinforcement panel. The front reinforcement panel and the back reinforcement panel are for being in at least partial face-to-face contact in the carrier formed from the blank and for forming a reinforcement portion extending from the front portion to the back portion of the carrier and for reinforcing the carrier formed from the blank. Gripping features for enhancing the grip of the carrier formed from the blank, the gripping features comprising at least one gripping panel extending between the bottom panel and one of the front side panel and the back side panel.

According to another aspect, the disclosure is generally directed to a method of forming a carrier for holding a plurality of containers, the method comprising obtaining a blank, the blank comprising a front portion, a back portion, and a reinforcement portion, one of the front portion and the back portion of the blank comprising at least a portion of an attachment panel for at least partially receiving a respective container of the plurality of containers, at least one side panel, a top panel, and a reinforcement panel, the carrier further comprising gripping features comprising at least one gripping region interrupting a fold line between the attachment panel and the at least one side panel. The method further comprises forming a front portion of the carrier from the front portion of the blank, forming a back portion of the carrier from the back portion of the blank, and forming a reinforcement portion of the carrier from the reinforcement portion of the blank such that the reinforcement portion extends from the front portion of the carrier to the back portion of the carrier. The method further comprises positioning the gripping features for facilitating grasping of the carrier.

In another aspect, the disclosure is generally directed to a method of forming a carrier for holding a plurality of containers, the method comprising obtaining a blank, the blank comprising a bottom panel having a plurality of container retention features comprising a respective bottom container retention opening and a respective plurality of bottom container retention flaps foldably connected to the bottom panel. The blank comprising a front portion and a back portion, the front portion of the blank comprising a first portion of the bottom panel including front bottom container retention features of the plurality of bottom container retention features, at least one front side panel foldably connected to the bottom panel, and a front reinforcement panel, the back portion of the blank comprising a second portion of the bottom panel including back bottom container retention features of the plurality of bottom container retention features, at least one back side panel, and a back reinforcement panel. The blank comprises gripping features comprising at least one gripping panel extending between the bottom panel and one of the front side panel and the back side panel. The method comprises positioning the bottom panel to engage a respective container of the plurality of containers and the bottom container retention flaps cooperate with bottom container retention openings to engage a respective container of the plurality of containers, forming a front portion of the carrier from the front portion of the blank and forming a back portion of the carrier from the back portion of the blank, forming a reinforcement portion of the carrier extending between the front portion of the carrier and the back portion of the carrier by positioning the front reinforcement panel and the back reinforcement panel in at least partially face-to-face contact to reinforce the carrier, and forming gripping features in the carrier from the gripping features of the blank to enhance the grip of the carrier.

According to another aspect, the disclosure is generally directed to a package comprising a carrier holding a plurality of containers, the carrier comprising a front portion, a back portion, and a reinforcement portion extending from the front portion to the back portion for reinforcing the carrier, one of the front portion and the back portion of the carrier comprising at least a portion of an attachment panel, at least one side panel, a top panel, and a reinforcement panel, the carrier further comprising at least one gripping region interrupting a fold line between the attachment panel and the at least one side panel for facilitating grasping of the carrier.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is an exterior plan view of a blank for forming a carrier and package according to a first embodiment of the disclosure.

FIG. 1A is an enlarged view of a portion of the blank of FIG. 1.

FIG. 1B is an enlarged view of another portion of the blank of FIG. 1.

FIG. 1C is an enlarged view of another portion of the blank of FIG. 1.

FIG. 1D is an enlarged view of another portion of the blank of FIG. 1.

FIG. 1E is an enlarged view of another portion of the blank of FIG. 1.

FIG. 1F is an enlarged view of another portion of the blank of FIG. 1.

FIG. 2 is a perspective schematic view of a container for use with carriers according to present disclosure.

FIGS. 2A-2D are perspective views showing a carrier of the first embodiment being formed by the blank of FIG. 1.

FIG. 3 is a front perspective view of the carrier of the first embodiment.

FIG. 4 is a bottom perspective view of the carrier of the first embodiment.

FIG. 5 is a bottom perspective view of the carrier of the first embodiment being grasped.

FIG. 6 is an exterior plan view of a blank for forming a carrier and package according to a second embodiment of the disclosure.

FIG. 7 is a plan view of the blank of FIG. 8 during formation of the carrier of the second embodiment.

FIG. 8 is a perspective view of the carrier of the second embodiment.

FIG. 9 is a side elevation view of the carrier of the second embodiment.

FIG. 10 is an end perspective view of the carrier of the second embodiment.

FIG. 11 is an enlarged end view of the carrier of the first embodiment.

Corresponding parts are designated by corresponding reference numbers throughout the drawings.

### DETAILED DESCRIPTION OF THE EXEMPLARY EMBODIMENTS

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., plastic containers) at least partially disposed within the carrier embodiments. In this specification, the terms “lower,” “bottom,” “upper,” “top,” “front,” and “back” indicate orientations determined in relation to fully erected carriers.

As described herein, carriers may be formed by multiple overlapping panels, end flaps, and/or other portions of blanks. Such panels, end flaps, and/or other portions of the blank can be designated in relative terms to one another, e.g., “first”, “second”, “third”, etc., in sequential or non-sequential reference, without departing from the disclosure.

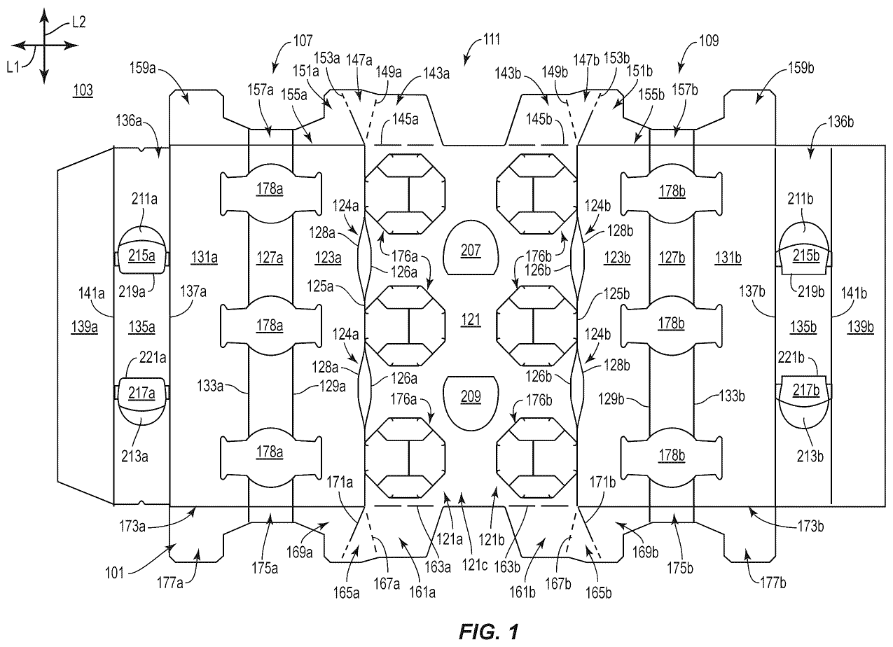

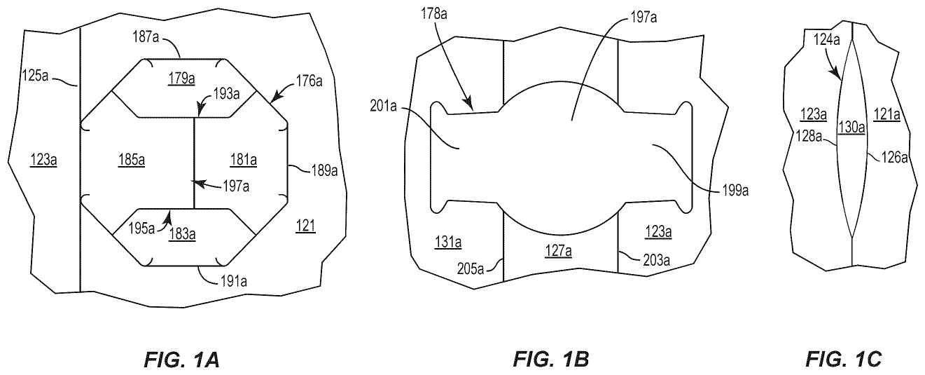

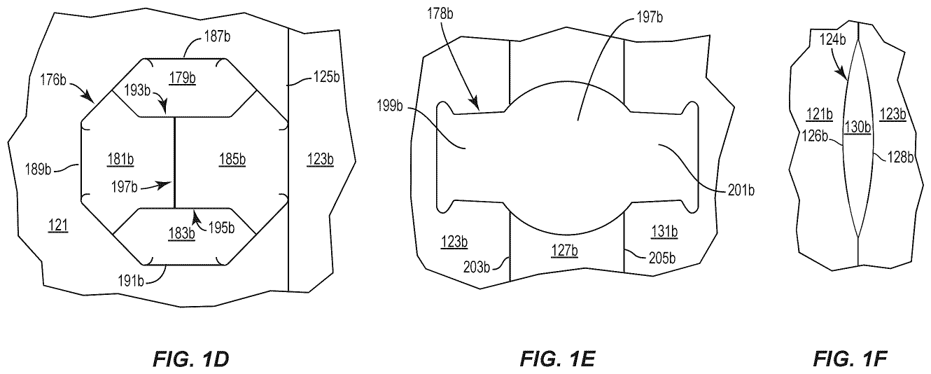

FIG. 1 shows a plan view of an exterior side 101 of a blank 103 used to form a carrier 105 (FIG. 3) in accordance with a first exemplary embodiment of the disclosure. As shown in FIG. 3, the carrier 105 is sized to contain or support six containers B, with three containers B being attached to a front portion 106 of the carrier 105 and three containers B being attached to a back portion 108 of the carrier 105.

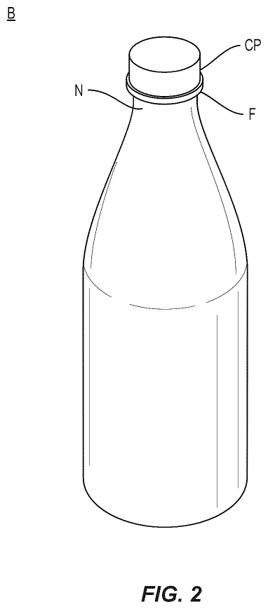

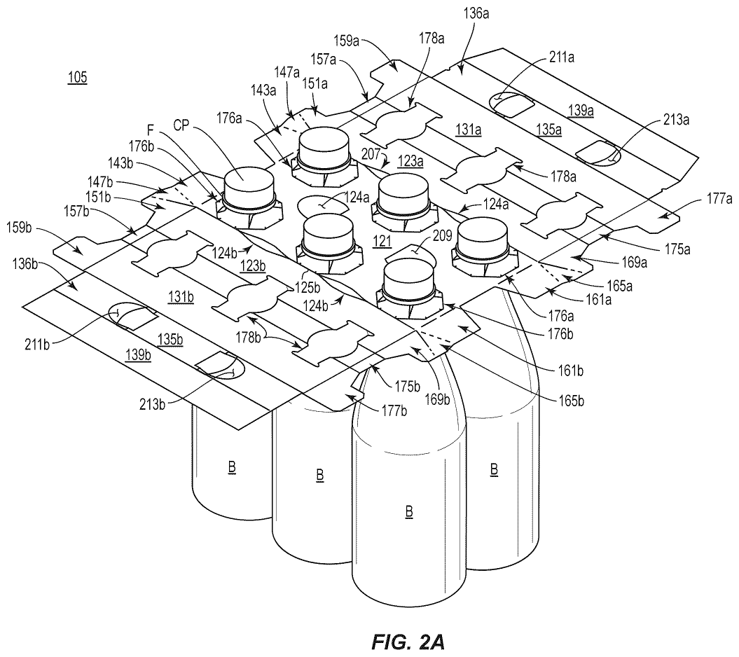

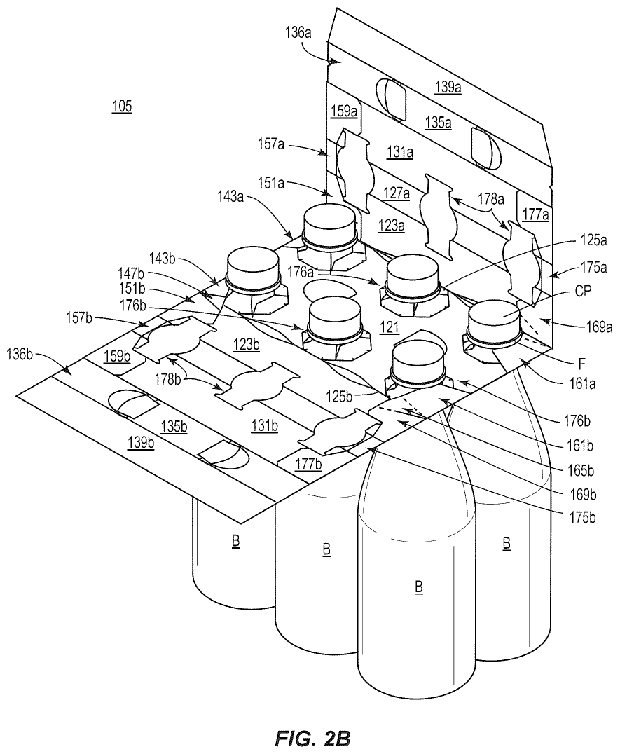

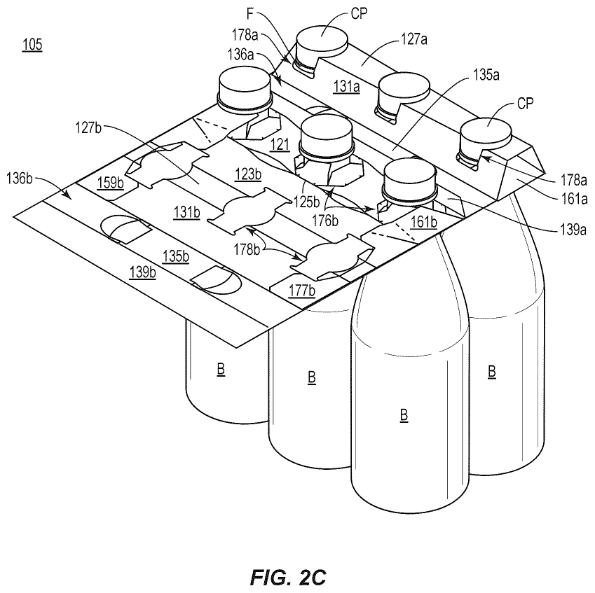

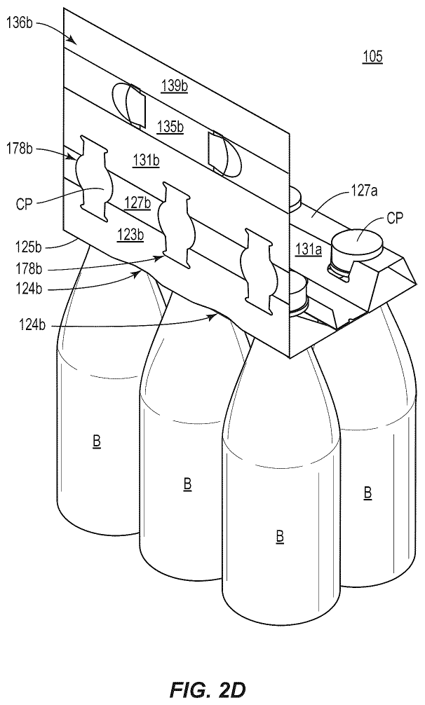

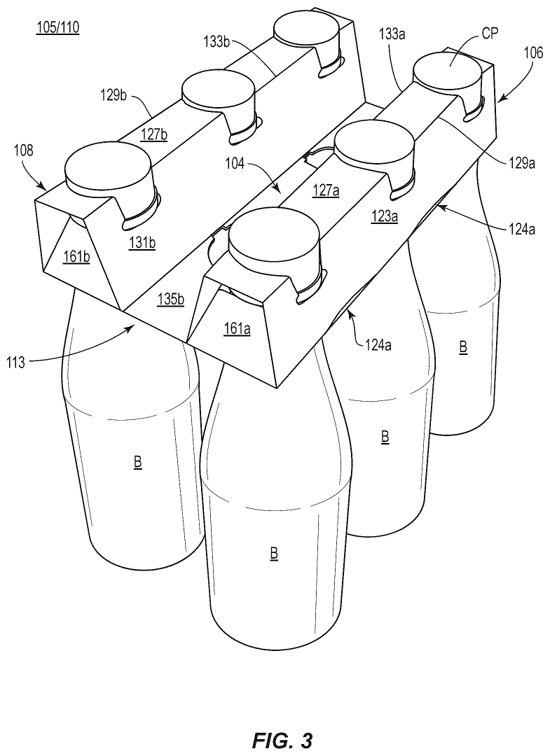

With momentary reference to FIG. 2, in the illustrated embodiment, containers B for use with carriers according to exemplary embodiments of the present disclosure can be bottles, e.g., plastic bottles formed of polyethylene terephthalate (PET) or another polymer, and having a body that includes lower and middle portions in a generally elongate vertical configuration, and having upper portions that include an at least partially tapered neck portion N intersecting a flange F that at least partially supports a cap or top portion CP closing the container B at the top of the containers, but other containers may be retained by the carrier 105 without departing from the disclosure. In other embodiments, the containers B could be beverage cans or another suitable type and size of container.

The carrier 105 can be sized and shaped to hold more or less than six containers. In one embodiment, the front portion 106 and the back portion 108 of the carrier 105 each have three containers, and in other embodiments, the front portion 106 and the back portion 108 of the carrier 105 can carry more or less than three containers without departing from the disclosure. The carrier 105 can be provided together with one or more containers as a package 110 (FIG. 2). In one embodiment, the carrier 105 is sized to house six containers B in a single layer in a 3×2 arrangement, but it is understood that the carrier 105 may be sized and shaped to hold containers of a different or same quantity in different row/column arrangements (e.g., 2×2, 1×6, 2×6, 4×6,3×8, 3×4, 2×9, 3×6, etc.), or just a single article.

As shown in FIG. 1, the blank 103 has a longitudinal axis L1 and a lateral axis L2. The blank 103 has a front portion 107 for forming the front portion 106 of the carrier 105 that holds a first or front row of containers B, a back portion 109 for forming the back portion 108 of the carrier 105 that holds a second or back row of containers B, and a central or reinforcement portion 111 for forming a central or reinforcement portion 113 of the carrier 105 extending from the front portion 106 of the carrier 105 to the back portion 108 of the carrier 105 for reinforcing the carrier 105. In various embodiments, the blank 103 includes features for forming gripping features of the carrier 105 for enhancing the grip of the carrier 105 to facilitate lifting or carrying the carrier 105/package 110.

The blank 103 can include a plurality of panels that can include a bottom panel/attachment panel 121 that has a first or front portion 121a, a second or back portion 121b, and a third or central portion 121c positioned at least partially between the front portion 121a and the back portion 121b, as described further herein.

A front outer side panel 123a (broadly, “side panel” or “front side panel”) is foldably connected to the bottom panel 121 at a lateral fold line 125a, that is interrupted by a series of gripping features 124a, as described further herein. In one embodiment, the gripping features 124a extend between the bottom panel 121 and the front outer side panel 123a, but the gripping features could be otherwise positioned without departing from the disclosure.

A front top panel 127a is foldably connected to the front outer side panel 123a at a lateral fold line 129a. The front top panel 127a is foldably connected to a front inner side panel 131a at a lateral fold line 133a. A front reinforcement panel 136a, as shown, includes a base portion 135a foldably connected to the front outer side panel 131a at a lateral fold line 137a and a distal portion 139a foldably connected to the front reinforcement panel 135a at a lateral fold line 141a.

In some embodiments, it will be understood that the side panels 123a, 131a and top panel 127a can be considered portions of a panel. In some embodiments, the side panel 123a and/or the reinforcement panel 135a can be considered a respective portion of such panel.

The blank 103 and the carrier 105 formed therefrom can also include a plurality of end flaps foldably connected to a respective panel of the plurality of panels. In the illustrated embodiment, a gusset end flap 143a is foldably connected to the bottom panel 121 at a longitudinal fold line 145a, and a gusset end flap 147a is foldably connected to the gusset end flap 143a at an oblique fold line 149a and to a gusset end flap 151a at an oblique fold line 153a.

The gusset end flap 151a is foldably connected to the outer side panel 123a at a longitudinal fold line 155a. A gusset end flap 157a is foldably connected to the gusset end flap 151a at a respective portion of the fold line 129a and to the top panel 127a at a respective portion of the fold line 155a such that the fold line 129a intersects the fold line 155a. Similarly, a gusset end flap 159a is foldably connected to the gusset end flap 157a at a respective portion of the fold line 133a and to the inner side panel 131a at a respective portion of the fold line 155a such that the fold line 133a intersects the fold line 155a.

With continued reference to FIG. 1, a gusset end flap 161a is foldably connected to the attachment panel 121 at a longitudinal fold line 163a, and a gusset end flap 165a is foldably connected to the gusset end flap 163a at an oblique fold line 167a and to a gusset end flap 169a at an oblique fold line 171a.

The gusset end flap 169a is foldably connected to the outer side panel 123a at a longitudinal fold line 173a. A gusset end flap 175a is foldably connected to the gusset end flap 169a at a respective portion of the fold line 129a and to the top panel 127a at a respective portion of the fold line 173a such that the fold line 129a intersects the fold line 173a. Similarly, a gusset end flap 177a is foldably connected to the gusset end flap 175a at a respective portion of the fold line 133a and to the inner side panel 131a at a respective portion of the fold line 173a such that the fold line 133a intersects the fold line 173a.

The blank 103 and the carrier 105 formed therefrom can also include container retention features for at least partially receiving a respective container B of the plurality of containers B. As shown in FIG. 1, container retention features 176a are positioned at least partially along the attachment panel 121a, and container retention features 178a can be at least partially positioned along the side panels 123a, 131a, and top panel 127a.

With additional reference to FIG. 1A, the container retention features 176a can include a container opening or container retention opening at least partially defined in the bottom panel 121. A first series of container retention tabs 179a, 181a, 183a, 185a are positioned extending into the container retention opening, foldably connected to the attachment panel 121 at a respective fold lines 187a (broadly, “longitudinal fold line”), 189a (broadly, “lateral fold line”), 191a (broadly, “longitudinal fold line”). As shown, the container retention tabs 185a are foldably connected to the remainder of the attachment panel 121 and/or to the outer side panel 123a at a respective portion of the fold line 125a.

As shown, the container retention tab 179a is at least partially separable from the adjacent container retention tabs 181a, 185a at respective portions of a cut 193a having one or more of straight, angled and/or curved segments. Similarly, the container retention tab 183a is at least partially separable from the adjacent container retention tabs 181a, 185a at respective portions of a cut 195a having one or more of straight, angled and/or curved segments. The container retention tabs 181a, 185a are at least partially separable at a lateral cut 197a extending from the cut 193a to the cut 195a. Alternatively, one or more of the container retention tabs 179a, 181a, 183a, 185a are alternatively shaped to have free edges that are spaced apart to form an opening between the container retention tabs for receiving the container B.

With continued reference to FIG. 1, and with additional reference to FIG. 1B, each container retention feature 178a is an opening including a respective central portion 197a, a respective outer portion 199a extending from the central portion 197a, and a respective inner portion 201a extending from the central portion 197a opposite the respective outer portion 199a. The respective outer portion 199a and respective inner portion 201a can have a generally rectangular shape with an at least partial taper toward the respective central portion 197a so as to at least partially define a shoulder therealong.

With additional reference to FIG. 1C, the gripping features 124a can include respective pairs of opposed convexly curved fold lines 126a, 128a (relative to a lateral centerline extending between the respective fold lines 126a, 128a) that at least partially define a gripping region or gripping panels 130a that are formed from a portion of the blank 103 between the bottom panel 121 and the outer side panel 123a. Alternative, the gripping panels 130a could be considered as being formed from a portion of one or more of the bottom panel 121 and the outer side panel 123a. The convexly curved fold lines 126a, 128a interrupt the lateral fold line 125a foldably connecting the bottom panel 121 and the outer side panel 123a and the gripping panels 130a are defined between the convexly curved fold line. In the illustrated embodiments, the convexly curved fold lines 126a, 128a defining the gripping panels 130a can be located laterally between adjacent container retention features 176a in the bottom panel 121.

The blank 103 and the carrier 105 formed therefrom can further include handle features for forming a handle 104 facilitating grasping or other engagement of the carrier 105 by a user. In the illustrated embodiment, the handle features can include a pair of finger openings or handle openings 207, 209 at least partially defined in the bottom panel 121. A pair of front attachment finger openings or handle openings 211a, 213a are at least partially defined in the central portion 135a of the front reinforcement panel 136a for at least partially aligning with the respective handle openings 207, 209 when the carrier 105 is formed from the blank 103.

Respective handle reinforcement flaps 215a, 217a are foldably connected to the reinforcement panel 136a at respective longitudinal fold lines 219a, 221a, are at least partially separable from the reinforcement panel 135a at respective cuts, and are positioned extending into the respective handle openings 211a, 213a.

In the illustrated embodiment, the back portion 109 of the blank 103 includes a back outer side panel 123b, a back inner side panel 131b, a back top panel 127b, a back reinforcement panel 136b with a base portion 135b and a distal portion 139b, gusset end flaps 143b, 147b, 151b, 157b, 159b, 161b, 165b, 169b, 175b, 177b having associated features that are generally a mirror-image of the corresponding portions of the front portion 107 of the blank 103. Corresponding components (e.g., panels, flaps, fold lines, cuts, etc.) have been designated by corresponding reference numbers that differ by the “a” or “b” suffix, with the “a” components corresponding to the front portion 107 of the blank 103 (and the front portion 106 of the carrier 105) and the “b” components corresponding to the back portion 109 of the blank 103 (and the back portion 108 of the carrier 105). FIGS. 1D and 1E are enlarged views of respective container retention features 176b, 178b and FIG. 1F is an enlarged view of the gripping features 124b.

Turning additionally to FIGS. 2A-3, an exemplary method of forming the blank 103 into the carrier 105 and package 110 will be described according to a first exemplary embodiment of the disclosure. A group of containers B can be organized, for example, in a row and/or column arrangement. In the illustrated embodiment, containers B can be organized in a 3×2 (row by column, from the perspective of FIG. 1) arrangement, though it will be understood that a different arrangement of containers B can be provided to suit a blank similar to but scaled differently than the blank 103.

In one exemplary method, the blank 103 is oriented with the exterior surface 101 facing upwardly and with an interior surface thereof, e.g., opposite the exterior surface 101, facing downwardly toward the containers B. The blank 103 can be lowered onto the containers B such that at least the respective top portions CP and flanges F of the respective containers B are at least partially received through the container retention features 176a, 176b.

Such relative movement of the blank 103 and containers B can cause the respective container retention tabs 179a, 181a, 183a, 185a to fold at least partially upwardly relative to the bottom panel 121 at the respective fold lines 187a, 189a, 191a, 125a toward a respective flange F of a respective container B. Relative separation of the container retention tabs 179a, 181a, 183a, 185a can occur at the respective cuts 193a, 195a, 197a.

Similarly, the container retention tabs 179b, 181b, 183b, 185b can separate from one another at the respective cuts 193b, 195b, 197b and can fold at least partially upwardly at the respective fold lines 187b, 189b, 191b, 125b toward a respective flange F of a container B.

In this regard, the respective container tab 179a, 179b, 181a, 181b, 183a, 183b, 185a, 185b can be positioned extending obliquely upwardly from a respective portion of the bottom panel 121 to an underside of a respective flange F of a respective container B, e.g., in a bracing relationship that maintains a tightened engagement between the blank 103/carrier 105 and the containers B. Such tightened engagement can minimize free space and/or relative movement between the blank 103/carrier 105 and the containers B.

With continued reference to FIGS. 2A-3, the front portion 106 of the carrier 105 is formed by positioning the side panel 123a into generally upright relation with the bottom panel 121 by at least partially folding at the fold line 125a (FIG. 2B). The top panel 127a is at least partially folded at the fold line 129a to be positioned into generally parallel and planar relation with the bottom panel 121 (FIG. 2C) and the front inner side panel 131a is at least partially folded at the fold line 133a to be positioned in generally downwardly depending relation with the top panel 127a (FIG. 2C). Also as shown in FIG. 2C, the reinforcement panel 136a is folded at the fold lines 137a and 223a so that the base portion 135a is positioned in at least partial face-to-face contact with the central portion 121c of the bottom panel 121, and the distal portion 139a is folded obliquely upwardly relative to the base portion 135a at the fold lines 141a and 225a to be positioned against the containers B in the back portion 108 of the carrier.

Similarly and as shown in FIGS. 2D and 3, the back portion 108 of the carrier 105 is formed in a similar manner as noted above for the front portion 106. The back outer side panel 123b is at least partially folded at the fold line 125b into generally upright relation with the bottom panel 121. The top panel 127b is at least partially folded at the fold lines 129b into generally parallel and planar relation with the bottom panel 121, and the back inner side panel 131b is at least partially folded at the fold lines 133b into generally downwardly depending relation with the top panel 127b. The back reinforcement panel 136b is folded at the fold lines 137b so that the base portion 135b is in at least partial face-to-face contact with the base portion 135a of the front reinforcement panel 136a. The distal portion 139b of the back reinforcement panel 136b is folded obliquely upwardly relative to the base portion 135b of the back reinforcement panel at the fold lines 141b so that the distal portion 139b is in at least partial face-to-face contact with the inner side panel 131a of the front portion 106 of the carrier 105. In some embodiments, a free edge of the distal portion 139b of the back reinforcement panel 136b can engage the flanges F of the containers B held in the front portion 106 of the carrier 105.

In such an arrangement, at least the respective flange F and respective top portion CP of the respective bottle B can be exposed extending at least partially through a respective container retention feature 178a, 178b. In some embodiments, the respective portions 199a, 199b, 201a, 201b of the respective container retention feature 178a, 178b can at least partially receive and/or contact a respective flange F of a respective container B.

In this regard, the respective container retention flaps 139a, 139b can be arranged such that a free edge thereof is positioned to contact the underside of a respective flange F of a respective container B, for example, in a bracing relationship extending from the respective reinforcement panel 135a, 135b.

As shown in FIGS. 2A-2C, during the formation of the carrier 105 the front gusset end flaps 143a, 151a, 155a, 157a, 159a and the back gusset end flaps 143b, 151b, 155b, 157b, 159b, 161b, 165b, 169b, 175b, 177b can be positioned to reinforce the carrier. The gusset end flaps 143 a, 151 a, 155 a, 157 a, 159 a can be folded at the respective fold lines 145 a, 155a/portions thereof so as to position the gusset end flaps 143a, 151a, 155a, 157a, 159a extending toward a respective outermost container B. In some embodiments, the gusset end flap 143a can be positioned extending from the bottom panel 121 to an underside of a respective flange F of a respective container B, e.g., in a bracing relationship. Accordingly, the gusset end flap 147a can be folded at the fold line 149a relative to the gusset end flap 143a and at the fold line 153a relative to the gusset end flap 151a so as to be positioned between the gusset end flaps 143a, 151a. The gusset end flaps 151a, 157a, 159a, in some embodiments, can be positioned in overlapping and/or at least partial face-to-face contact with respective interior surfaces (e.g., planarly opposite the exterior surface thereof) the respective side panel 123a, top panel 127a, and side panel 131a.

The gusset end flaps 161a, 165a, 169a, 175a, 177a can be folded at the respective fold lines 163 a, 173a/portions thereof so as to position the gusset end flaps 161 a, 165 a, 169 a, 175 a, 177a extending toward a respective outermost container B. In some embodiments, the gusset end flap 161a can be positioned extending from the bottom panel 121 to an underside of a respective flange F of a respective container B, e.g., in a bracing relationship. Accordingly, the gusset end flap 165a can be folded at the fold line 167a relative to the gusset end flap 161a and at the fold line 171a relative to the gusset end flap 169a so as to be positioned between the gusset end flaps 161a, 169a. The gusset end flaps 169a, 175a, 177a, in some embodiments, can be positioned in overlapping and/or at least partial face-to-face contact with respective interior surfaces (e.g., planarly opposite the exterior surface thereof) the respective side panel 123a, top panel 127a, and side panel 131a.

The gusset end flaps 143b, 151b, 155b, 157b, 159b, 161b, 165b, 169b, 175b, 177b of the back portion 109 of the blank 103/back portion 108 of the carrier 105 can be folded in a manner similar to that described above with respect to the gusset end flaps 143a, 151a, 155a, 157a, 159a, 161a, 165a, 169a, 175a, 177a.

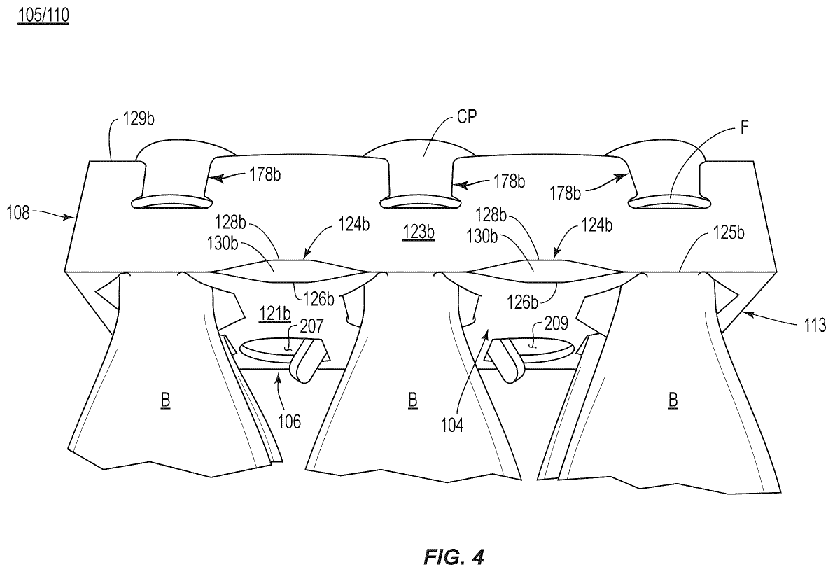

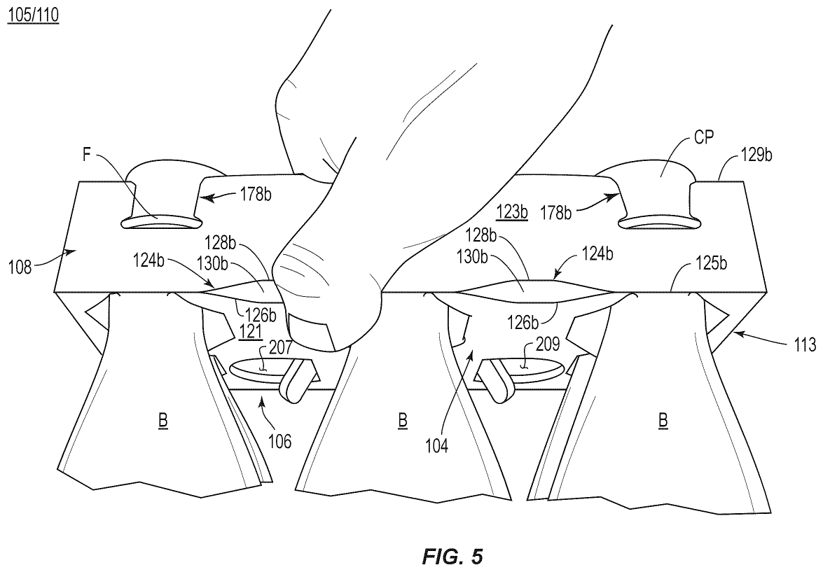

In the formed configuration of the carrier 105 and package 110, the handle openings 211a, 213a and associated handle flaps 215a, 217a in the front attachment panel 136a can align with the handle openings 207, 209 in the bottom panel 121 when the base portion 135a is positioned into overlapping face-to-face contact with the central portion 121c of the bottom panel 121. As the back attachment panel 136b is formed and positioned as shown in FIG. 4, the handle openings 211b, 213b and associated handle flaps 215b, 217b in the base portion 135b of the back attachment panel 136b can align with the handle openings 211a, 213a and associated handle flaps 215a, 217a in the base portion 135a of the front reinforcement panel 136a. The aligned handle openings 207, 209, 211a, 211b, 213a, 213b and associated handle flaps 215a, 217b form a handle 104 of the carrier 105 and package 110 when the front reinforcement panel 136a and back reinforcement panel 136b are positioned to form the reinforcement portion 113 of the carrier 105 that extends between the front portion 106 and the back portion 108 of the carrier 105.

As shown, the gripping features 124a, 124b can provide an enhanced grip of the carrier 105/package 10 that can include exteriorly-facing features on the front portion 106 of the carrier 105/package 110 and the back portion 108 of the carrier 105/package 110 that form the grip of the carrier 105/package 110 which provides a surface a user can contact to grasp the carrier 105/package 110. For example, the gripping features 124 a, 124 b can provide at least partially recessed portions along the carrier 105/package 110 that are at least partially ergonomically formed so as to interrupt hard edges formed, for example, by fold lines, and instead form a grip of the carrier 105/package 110 that presents at least partially curved and/or beveled regions, e.g., along the gripping panels 130a, 130b of the gripping regions 124a, 124b, that provide an enhanced grip that includes a comfortable surface for a user to exert gripping forces.

In some embodiments, the gripping features 124a, 124b can provide locating features for facilitating symmetric locations along the carrier 105/package 110 for a user to grasp the carrier 105/package 110, for example, in instances in which a user may not have a direct line of sight to the carrier 105/package 110, to adjust grip without averting gaze, etc. In some embodiments, the gripping features 124a, 124b can be located between adjacent containers B to facilitate access to the gripping features and to enhance the grip of the carrier 105/package 110.

In some embodiments, the gripping panels 130a, 130b can at least partially fold, e.g., collapse and/or recess, relative to surrounding portions of the carrier 105, for example, at the respective fold lines 126a, 126b, 128a, 128b, so as to disperse forces incidental to grasping the carrier 105 and to provide further comfort to a user's fingers. As shown in FIG. 4, the gripping panels 130a, 130b are positioned out of plane with the bottom 121 and the outer side panels 123a, 123.

The formed arrangement of the package 110 and carrier 105 is such to provide the front portion 106 thereof, the back portion 108 thereof, and the reinforcement portion 113 positioned between the front portion 106 and the back portion 108.

The reinforcement portion 113 is at least partially formed by the overlapping arrangement of the back reinforcement panel 136b, the front reinforcement panel 136a, and the reinforcement portion 121c of the bottom panel 121. Such an arrangement provides reinforcement to the carrier 105 in the course of movement or other loading, e.g., transportation, storage, carrying, incidental to use, etc. In this regard, the arrangement of reinforcement portion 121c of the attachment panel 121 provides the carrier 105 with an increased capacity to minimize, inhibit, avoid, prevent, and/or otherwise resist bending, bowing, flexing, buckling, curling, deflection, and/or other deformation.

The package 110/carrier 105 described above has a compact structure that can, for example, provide materials savings and waste reduction. Additionally, the positioning of the reinforcement portion 121 c of the attachment panel 121/reinforcement portion 113 between the front portion 106 and the back portion 108 of the carrier 105 results in a robust structure for holding and carrying the containers B. Further, the exposure of one or more portions of the containers B on exterior portions of the carrier 105/package 110 provides a consumer with a clear view of labeling or surface graphics associated with the containers B as well as providing convenient access to remove one or more of the containers B from the carrier 105/package 110.

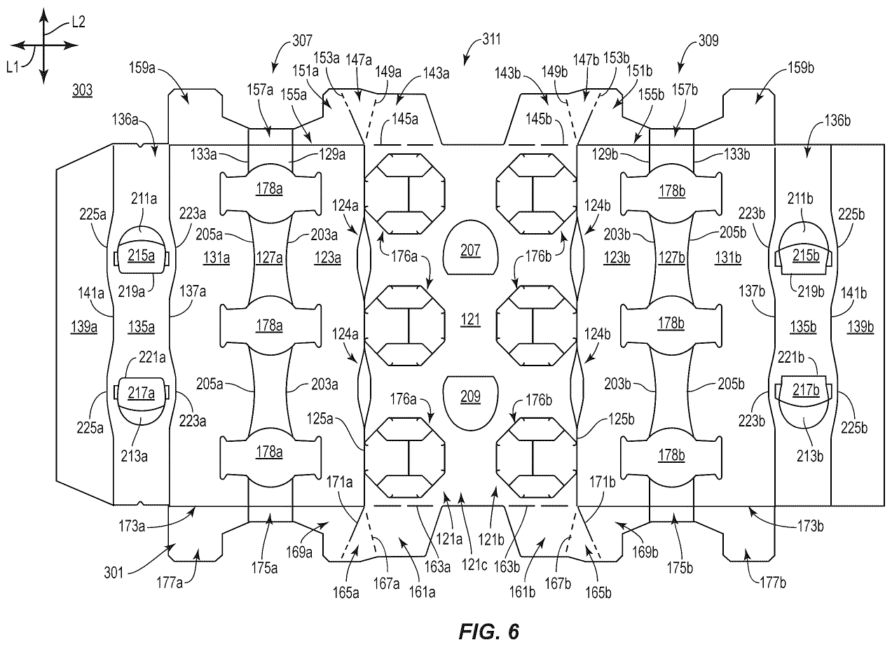

Turning to FIG. 6, the exterior surface 301 of a blank 303 for forming a carrier 305 according to a second exemplary embodiment of the disclosure is illustrated. The blank 303 and the carrier 305 formed therefrom can have one or more features that are the same or similar to those described above with respect to the blank 103 and carrier 105 formed therefrom according to the first exemplary embodiment of the disclosure, and like or similar features are designated with like or similar reference numerals. The carrier 305 can be provided with one or more containers B as a package 310. The carrier 305 can be configured to have stiffening features 202a, 202b that enhance the structural integrity of the carrier 305 by preventing flexing, bending, or other failures and handle access features 222a, 222b that provide expanded access to the handle 104 in the central/reinforcement portion 113 of the carrier 105.

As shown, the blank 303 can have a configuration generally similar to the blank 103 described above, e.g., so as to have a front portion 307 for forming a front portion 306 of the carrier 305/package 310, a back portion 309 for forming a back portion 308 of the carrier 305/package 310, and a reinforcement portion 311 for forming a reinforcement portion 313 of the carrier 305/package 310.

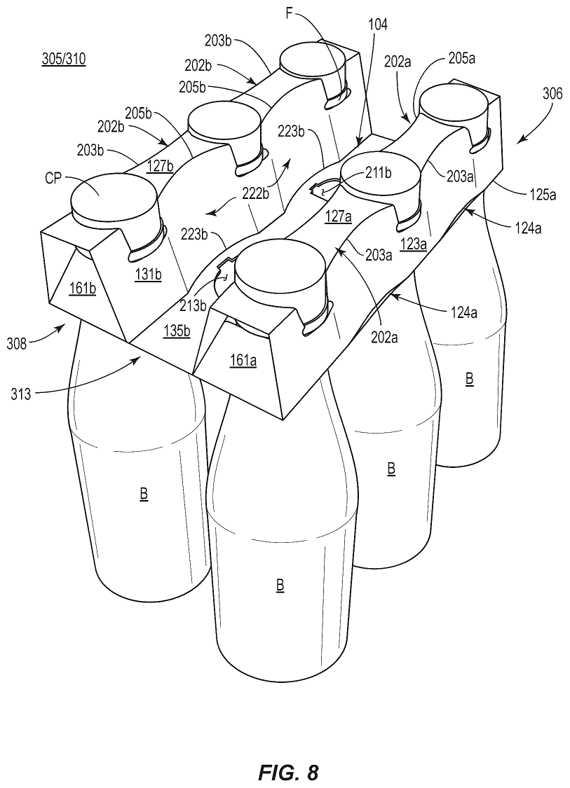

However, stiffening features 202 a (FIG. 8) of the blank 303 and the carrier 305 formed therefrom can include a plurality of spaced apart curved fold lines 203a interrupting the fold line 129a so as to extend adjacent respective portions of the outer side panel 123a and the top panel 127a. As shown, a respective curved fold line 203a can extend from a respective container retention features 178a to an adjacent container retention feature 178a.

Further, curved fold lines 205a are provided interrupting the fold line 133a and foldably connecting the front inner side panel 131a to the front top panel 127a. The curved fold lines 205a extend adjacent respective portions of the inner side panel 131a and the top panel 127a. As shown, a respective curved fold line 205a can extend from a respective container retention opening 178a in the front portion 307 of the blank 303.

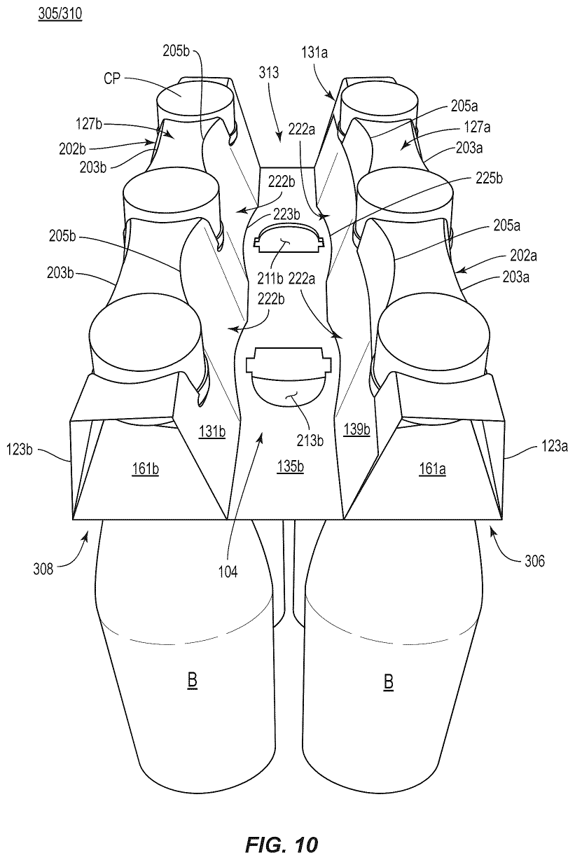

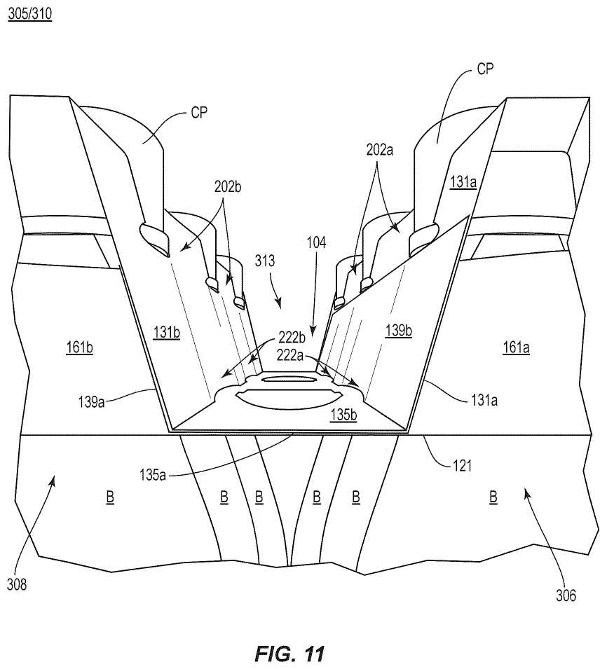

Referring still to FIGS. 10 and 11, handle access features 222a (FIG. 3) are at least partially defined in the reinforcement panel 136a and extend along one or more of the base portion 135a, the inner side panel 131a, and the distal portion 139a. In the illustrated embodiment, the handle access features can include a pair of laterally-spaced curved fold lines 223a interrupting the fold line 137a, and a pair of laterally spaced curved fold lines 225a interrupting the fold line 141a. As shown, the respective curved fold lines 223a, 225a are arranged so as to curve away from one another, e.g., such that the respective curved fold lines 223a, 225a are convex with respect to a line parallel to the lateral axis L2 and positioned therebetween so as to define an enlarged region longitudinally adjacent each handle opening 211 a, 213a/handle reinforcement flap 215 a, 217 a. The curved fold lines 223a foldably connect the front outer side panel 131a and the base portion 135a of the reinforcement panel 136. The curved fold lines 225a foldably connect the base portion 135a of the reinforcement panel 136 and the distal portion 139b of the reinforcement panel.

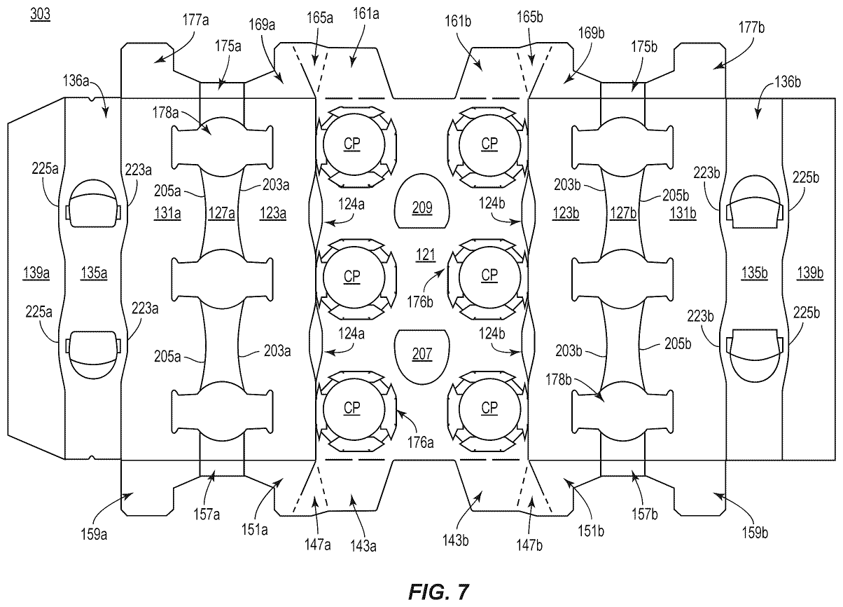

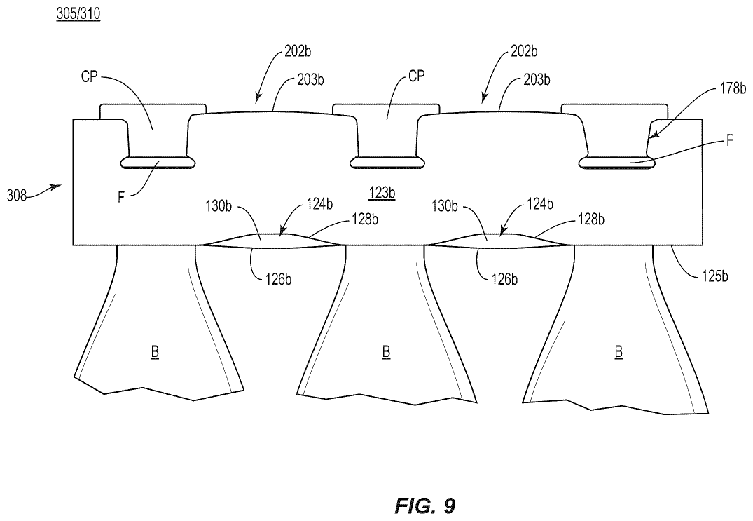

With additional reference to FIGS. 6-11, the carrier 305 and package 310 can be formed from the blank 303 in a manner similar to that described above with respect to the formation of the carrier 105 and package 110 from the blank 103, with the blank 303 first being attached to the caps CP of the containers B as shown in FIG. 7. Further, the panels and features of the blank 303 can be further folded and formed to form the front portion 306 of the carrier 305, the back portion 308 of the carrier 305, and the reinforcement portion 313 of the carrier 305 in a similar manners as the carrier 105 as described above.

However, as shown in FIGS. 6-8, the handle access features 222a, 222b can provide expanded regions that curve outwardly from the handle openings 207, 209, 211a, 211b, 213a, 213b by virtue of the arrangement of the curved fold lines 223a, 225a, 223b, 225b that provide a correspondingly curved arrangement of the inner side panels 131a, 131b. Such expanded regions around the handle openings 207, 209, 211a, 211b, 213a, 213b can provide convenient access for a user protruding portions of his or her hands between the front portion 107 and the back portion 109 of the package 110/carrier 105, e.g., portions such as knuckles/joints, etc., that could otherwise restrict access to such regions.

Furthermore, in some embodiments, the handle access features 222a, 222b can be arranged so as to create pressure on the respective inner side panels 131a, 131b to maintain the arrangement thereof relative to the remainder of the carrier 105/package 110. The curved fold lines 223a, 223b, 225a, 225b can further be characterized as stiffening features that provide enhanced structural integrity of the carrier 105 and package 110.

In this regard, a user can press against one or more of the handle flaps 215b, 217b to cause the handle flap 215b, 217b to fold at least partially downwardly at the respective fold lines 219b, 221b and urge a respective handle flap 215a, 217a therebelow to fold downwardly at a respective fold line 219a, 221a into the respective handle opening 207, 209 therebelow. In some embodiments, one or more of the handle flaps 215a, 215b, 217a, 217b can be positioned between a user's finger(s) and the underside of the attachment panel 121, for example, for comfort, to avoid pinching, for strength, to avoid unwanted tearing or other damage to the package 110/carrier 105, etc.

As shown, the stiffening features 202a, 202b of the blank 103 and carrier 105 formed therefrom can form arched regions along the top of the carrier 105 that tend to disperse applied stresses away therefrom, e.g., across the remainder of the carrier 105 therebelow in a distributed fashion. Accordingly, the carrier 105/package 110 is constructed so as to minimize, inhibit, prevent, or otherwise avoid the accumulation of stresses incidental to use of the carrier 105, for example, due to lifting, carrying, other movement, etc., that could contribute to unwanted tearing or other damage of the package/carrier 110. In some embodiments, the stiffening features 202 a that increase the strength of the front portion 106 of the carrier 105 and resist bending/failure of the carton include the curved fold lines 203a, 205a, 223a that from generally curved portions of the front inner side panel 131a and the front outer side panel 123a that extend between respective containers B in the front portion. Further, the stiffening features 202a in the front portion 106 of the carrier 105 can include the curved fold lines 225b of the back reinforcement panel 136b that overlap a respective curved fold line 223a. Similarly, the stiffening features 202b in the back portion 108 of the carrier 105 can include the curved fold lines 203b, 205b, 223b that form generally curved portions of the back inner side panel 131b and the back outer side panel 123b that extend between respective containers B in the back portion. Further, the stiffening features 202b in the back portion 108 of the carrier 105 can include the curved fold lines 225a of the front reinforcement panel 136a that overlap a respective curved fold line 223b. The stiffening features 202a, 202b could be otherwise shaped, arranged, and/or configured without departing from the disclosure.

Furthermore, in some embodiments, the arrangement of the stiffening features 202a, 202b is such that respective portions of the top panels 127a, 127b are positioned to contact the respective cap CP of a respective container B so as to maintain a relative position of the container B with respect to a remainder of the carrier 105/package 110, e.g., such that the respective container B is minimized, inhibited, and/or prevented from shifting and/or rotating (so as to maintain a presentation of exterior labeling or surface indicia of the container B). In some embodiments, the fold lines 203a, 205a that form the stiffening features 202a can be positioned as opposed folds lines that are concave relative to the top panel 127a and the lateral axis L2 of the blank. Similarly, the fold lines 203b, 205b that form the stiffening features 202b can be positioned as opposed fold lines that are concave relative to the top panel 127b and the lateral axis L2 of the blank. The stiffening features 202a, 202b can include other features without departing from the disclosure.

In exemplary embodiments, the clip-style carriers of the disclosed embodiments can provide increased stability, resistance, and strength, as well as a comfortable and reliable carry experience. The carriers can be adapted to be suitable for multiple bottle types, sizes, and configurations. The carriers and packages can be formed/assembled manually and/or by machine. In embodiments, the structure of the carriers can be shaped around the top portions T of the containers B (e.g., the bottle caps CP) to facilitate increasing the rigidity of the packages.

The carriers of any of the illustrated or non-illustrated embodiments of the disclosure could have other features (e.g., dispenser features, handle features, reinforcement features, gripping features, etc.) without departing from the disclosure. Also, the carriers could be otherwise shaped, arranged, and/or configured and the carriers could be configured to hold articles other than beverage containers B without departing from the disclosure.

Any of the features of the various embodiments of the disclosure can be combined with, replaced by, or otherwise configured with other features of other embodiments of the disclosure without departing from the scope of this disclosure. The carrier styles and panel configurations described above are included by way of example.

In general, the blanks may be constructed from paperboard having a caliper so that it is heavier and more rigid than ordinary paper. The blanks can also be constructed of other materials, such as cardboard, or any other material having properties suitable for enabling the carrier to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The above embodiments may be described as having one or panels adhered together by glue. The term “glue” is intended to encompass all manner of adhesives commonly used to secure paperboard carton panels in place.

The term “line” as used herein includes not only straight lines, but also other types of lines such as curved, curvilinear or angularly displaced lines.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The foregoing description of the disclosure illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments, but other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure without departing from the scope of the disclosure.

Additionally, spatially relative terms, such as “bottom or “top”; or “front” or “back”; and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” “exemplary embodiments”, or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” “in some embodiments”, or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A carrier for holding a plurality of containers, the carrier comprising:
a bottom panel for at least partially receiving a respective container of the plurality of containers, the bottom panel having a plurality of container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers;
a front portion, the front portion comprising a first portion of the bottom panel including front bottom container retention features of the plurality of bottom container retention features, at least one front side panel foldably connected to the bottom panel, and a front reinforcement panel;
a back portion, the back portion comprising a second portion of the bottom panel including back bottom container retention features of the plurality of bottom container retention features, at least one back side panel, and a back reinforcement panel;
a reinforcement portion extending from the front portion to the back portion for reinforcing the carrier, the reinforcement portion comprises the front reinforcement panel and the back reinforcement panel in at least partial face-to-face contact; and
gripping features for enhancing the grip of the carrier, the gripping features comprising at least one gripping panel extending between the bottom panel and one of the front side panel and the back side panel.

2. The carrier of claim 1, wherein the gripping panel is defined by at least one curved fold line between the bottom panel and the one of the front side panel and the back side panel.

3. The carrier of claim 2, wherein the at least one curved fold line is a pair of curved fold lines and the gripping panel is defined between the fold lines.

4. The carrier of claim 3, wherein the pair of curved fold lines interrupt a lateral fold line foldably connecting the bottom panel and the one of the front side panel and the back side panel.

5. The carrier of claim 4, wherein pair of curved fold lines include a pair of opposed convexly curved fold lines.

6. The carrier of claim 5, wherein the at least one gripping panel is a front gripping panel extending between the bottom panel and the front side panel, and the at least one gripping panel comprises a back gripping panel extending between the bottom panel and the back side panel, the pair of curved fold lines is a front pair of curved fold lines defining the front gripping panel, the at least one curved fold line comprises a back pair of curved fold lines defining the back gripping panel.

7. The carrier of claim 2, wherein the gripping panel is positioned out of plane with the bottom panel and the one of the front side panel and the back side panel.

8. The carrier of claim 7, wherein the gripping panel is located between two adjacent containers of the plurality of containers.

9. The carrier of claim 1, wherein the at least one front side panel is an outer front side panel, the front portion comprises a front top panel foldably connected to the outer front side panel, and a front inner side panel foldably connected to the front top panel,
the at least one back side panel is an outer back side panel, the back portion comprises a back top panel foldably connected to the outer back side panel, and a back inner side panel foldably connected to the back top panel,
the at least one gripping panel includes a front gripping panel extending between the bottom panel and the front outer side panel and a back gripping panel extending between the bottom panel and the back outer side panel.

10. The carrier of claim 9, further comprises stiffening features for increasing the strength of the carrier, the stiffening features comprising a first front curved fold line foldably connecting the front top panel to the front outer side panel, a second front curved fold line foldably connected the front top panel to the front inner side panel, a first back curved fold line foldably connecting the back top panel and the outer back side panel, a second back curved fold line foldably connected to the back top panel and the back inner side panel.

11. The carrier of claim 10, wherein the at least one front curved fold line is a first front curved fold line foldably connecting the front top panel and the front outer side panel, the at least one front curved fold line comprises a second front curved fold line foldably connecting the front top panel and the front inner side panel.

12. The carrier of claim 11, wherein the at least one back curved fold line is a first back curved fold line foldably connecting the back top panel and the outer back side panel, the at least one back curved fold line comprises a second back curved fold line foldably connected to the back top panel and the back inner side panel.

13. The carrier of claim 12, wherein the front reinforcement panel is foldably connected to the front inner side panel and the back reinforcement panel is foldably connected to the back inner side panel, the stiffening features comprise a third front curved fold line foldably connecting the front reinforcement panel and the front inner side panel and a third back curved fold line foldably connecting the back reinforcement panel and the back inner side panel.

14. The carrier of claim 13, wherein the front reinforcement panel and the back reinforcement panel include handle features for cooperating to form a handle of the carrier,
the second front curved fold line, the second back curved fold line, the third front curved fold line, and the third back curved fold line cooperate to form a handle access feature that extends outwardly from the handle in the reinforcement portion and provides expanded access to the handle.

15. A blank for forming a carrier for holding a plurality of containers, the blank comprising:
a bottom panel for at least partially receiving a respective container of the plurality of containers in the carrier formed from the blank, the bottom panel having a plurality of container retention features for at least partially engaging a respective container of the plurality of containers, the plurality of container retention features comprising a respective bottom container retention opening and a respective plurality of bottom container retention flaps foldably connected to the bottom panel and cooperating with the bottom container retention opening to engage a respective container of the plurality of containers in the carrier formed from the blank;
a front portion for forming a front portion of the carrier formed from the blank, the front portion of the blank comprising a first portion of the bottom panel including front bottom container retention features of the plurality of bottom container retention features, at least one front side panel foldably connected to the bottom panel, and a front reinforcement panel;
a back portion for forming a back portion of the carrier formed from the blank, the back portion of the blank comprising a second portion of the bottom panel including back bottom container retention features of the plurality of bottom container retention features, at least one back side panel, and a back reinforcement panel;
the front reinforcement panel and the back reinforcement panel are for being in at least partial face-to-face contact in the carrier formed from the blank and for forming a reinforcement portion extending from the front portion to the back portion of the carrier and for reinforcing the carrier formed from the blank; and
gripping features for enhancing the grip of the carrier formed from the blank, the gripping features comprising at least one gripping panel extending between the bottom panel and one of the front side panel and the back side panel.

16. The blank of claim 15, wherein the gripping panel is defined by at least one curved fold line between the bottom panel and the one of the front side panel and the back side panel.

17. The carrier of claim 16, wherein the at least one curved fold line is a pair of curved fold lines and the gripping panel is defined between the fold lines.

18. The blank of claim 17, wherein the pair of curved fold lines interrupt a lateral fold line foldably connecting the bottom panel and the one of the front side panel and the back side panel.

19. The blank of claim 18, wherein pair of curved fold lines include a pair of opposed convexly curved fold lines.

20. The blank of claim 19, wherein the at least one gripping panel is a front gripping panel extending between the bottom panel and the front side panel, and the at least one gripping panel comprises a back gripping panel extending between the bottom panel and the back side panel, the pair of curved fold lines is a front pair of curved fold lines defining the front gripping panel, the at least one curved fold line comprises a back pair of curved fold lines defining the back gripping panel.

21. The blank of claim 15, wherein the at least one front side panel is an outer front side panel, the front portion comprises a front top panel foldably connected to the outer front side panel, and a front inner side panel foldably connected to the front top panel,
the at least one back side panel is an outer back side panel, the back portion comprises a back top panel foldably connected to the outer back side panel, and a back inner side panel foldably connected to the back top panel,
the at least one gripping panel includes a front gripping panel extending between the bottom panel and the front outer side panel and a back gripping panel extending between the bottom panel and the back outer side panel.

22. The blank of claim 21, further comprising stiffening features for increasing the strength of the carrier formed from the blank, the stiffening features comprising a first front curved fold line foldably connecting the front top panel to the front outer side panel, a second front curved fold line foldably connected the front top panel to the front inner side panel, a first back curved fold line foldably connecting the back top panel and the outer back side panel, a second back curved fold line foldably connected to the back top panel and the back inner side panel.

23. The blank of claim 22, wherein the at least one front curved fold line is a first front curved fold line foldably connecting the front top panel and the front outer side panel, the at least one front curved fold line comprises a second front curved fold line foldably connecting the front top panel and the front inner side panel,
the at least one back curved fold line is a first back curved fold line foldably connecting the back top panel and the outer back side panel, the at least one back curved fold line comprises a second back curved fold line foldably connected to the back top panel and the back inner side panel.

24. The blank of claim 23, wherein the front reinforcement panel is foldably connected to the front inner side panel and the back reinforcement panel is foldably connected to the back inner side panel, the stiffening features comprise a third front curved fold line foldably connecting the front reinforcement panel and the front inner side panel and a third back curved fold line foldably connecting the back reinforcement panel and the back inner side panel.

25. The blank of claim 24, wherein the front reinforcement panel and the back reinforcement panel include handle features for cooperating to form a handle of the carrier formed from the blank,
the second front curved fold line, the second back curved fold line, the third front curved fold line, and the third back curved fold line cooperate to form a handle access feature that extends outwardly from the handle in the reinforcement portion and provides expanded access to the handle in the carrier formed from the blank.

26. A method of forming a carrier for holding a plurality of containers, the method comprising:
obtaining a blank, the blank comprising a bottom panel having a plurality of container retention features comprising a respective bottom container retention opening and a respective plurality of bottom container retention flaps foldably connected to the bottom panel;
the blank comprising a front portion and a back portion, the front portion of the blank comprising a first portion of the bottom panel including front bottom container retention features of the plurality of bottom container retention features, at least one front side panel foldably connected to the bottom panel, and a front reinforcement panel, the back portion of the blank comprising a second portion of the bottom panel including back bottom container retention features of the plurality of bottom container retention features, at least one back side panel, and a back reinforcement panel, the blank comprises gripping features comprising at least one gripping panel extending between the bottom panel and one of the front side panel and the back side panel;
positioning the bottom panel to engage a respective container of the plurality of containers and the bottom container retention flaps cooperate with bottom container retention openings to engage a respective container of the plurality of containers;
forming a front portion of the carrier from the front portion of the blank and forming a back portion of the carrier from the back portion of the blank;
forming a reinforcement portion of the carrier extending between the front portion of the carrier and the back portion of the carrier by positioning the front reinforcement panel and the back reinforcement panel in at least partially face-to-face contact to reinforce the carrier; and
forming gripping features in the carrier from the gripping features of the blank to enhance the grip of the carrier.

27. The method of claim 26, wherein the gripping panel is defined by at least one curved fold line between the bottom panel and the one of the front side panel and the back side panel and the forming gripping features comprises positioning the gripping panel out of plane with the bottom panel and the one of the front side panel and the back side panel.

28. The method of claim 27, wherein the at least one curved fold line is a pair of curved fold lines and the gripping panel is defined between the fold lines.

29. The method of claim 28, wherein the pair of curved fold lines interrupt a lateral fold line foldably connecting the bottom panel and the one of the front side panel and the back side panel, the pair of curved fold lines include a pair of opposed convexly curved fold lines, and the at least one gripping panel is a front gripping panel extending between the bottom panel and the front side panel, and the at least one gripping panel comprises a back gripping panel extending between the bottom panel and the back side panel, the pair of curved fold lines is a front pair of curved fold lines defining the front gripping panel, the at least one curved fold line comprises a back pair of curved fold lines defining the back gripping panel.

30. The method of claim 26, wherein the at least one front side panel is an outer front side panel, the front portion comprises a front top panel foldably connected to the outer front side panel, and a front inner side panel foldably connected to the front top panel,
the at least one back side panel is an outer back side panel, the back portion comprises a back top panel foldably connected to the outer back side panel, and a back inner side panel foldably connected to the back top panel,
the at least one gripping panel includes a front gripping panel extending between the bottom panel and the front outer side panel and a back gripping panel extending between the bottom panel and the back outer side panel.

31. The method of claim 30, wherein the blank further comprises stiffening features and the method comprising forming stiffening features in the carrier from the stiffening features of the blank, the stiffening features in the carrier to increase the strength of the carrier, the stiffening features comprising a first front curved fold line foldably connecting the front top panel to the front outer side panel, a second front curved fold line foldably connected the front top panel to the front inner side panel, a first back curved fold line foldably connecting the back top panel and the outer back side panel, a second back curved fold line foldably connected to the back top panel and the back inner side panel.

32. The method of claim 31, wherein the at least one front curved fold line is a first front curved fold line foldably connecting the front top panel and the front outer side panel, the at least one front curved fold line comprises a second front curved fold line foldably connecting the front top panel and the front inner side panel,
the at least one back curved fold line is a first back curved fold line foldably connecting the back top panel and the outer back side panel, the at least one back curved fold line comprises a second back curved fold line foldably connected to the back top panel and the back inner side panel.

33. The method of claim 32, wherein the front reinforcement panel is foldably connected to the front inner side panel and the back reinforcement panel is foldably connected to the back inner side panel, the stiffening features comprise a third front curved fold line foldably connecting the front reinforcement panel and the front inner side panel and a third back curved fold line foldably connecting the back reinforcement panel and the back inner side panel,
the front reinforcement panel and the back reinforcement panel include handle features and the method comprises forming a handle of the carrier from the handle features,
the second front curved fold line, the second back curved fold line, the third front curved fold line, and the third back curved fold line cooperate to form a handle access feature that extends outwardly from the handle in the reinforcement portion and provides expanded access to the handle in the carrier formed from the blank.
